(19) United States
(12) Patent Application Publication
(10) Pub. No.: US 2017/0300972 A1
(43) Pub. Date: Oct. 19, 2017

(54) SYSTEM FOR PROVIDING ADVERTISEMENT, METHOD FOR PROVIDING ADVERTISEMENT USING BEACON BASED ON MOVEMENT OF USER AND APPARATUS USING THE SAME

(71) Applicant: SK Planet Co., Ltd., Seongnam-Si (KR)

(72) Inventor: Seung-Hoon MOON, Seoul (KR)

(21) Appl. No.: 15/376,664

(22) Filed: Dec. 13, 2016

(30) Foreign Application Priority Data
Apr. 18, 2016 (KR) 10-2016-0047047

(51) Int. Cl. G06Q 30/02

(52) U.S. Cl. CPC G06Q 30/0261; G06Q 30/0267

(57) ABSTRACT

Disclosed are an advertisement provision system, a method for providing an advertisement using a beacon based on the movement of users, and an apparatus using the same. In the method, multiple neighboring beacons located around a reference beacon installed in a membership store are searched for based on the location of the reference beacon, a target route corresponding to the membership store is acquired, whether an expanded range-based advertisement can be provided using a target beacon corresponding to the target route is checked, and an advertisement for the membership store may be provided when it is determined that the expanded range-based advertisement can be provided using the target beacon. Therefore, the advertisement based on an expanded area may be provided using not only a beacon installed in a specific membership store for advertisement but also beacons installed in other affiliate stores that have joined as members.

### CROSS REFERENCE TO RELATED APPLICATION

This application claims the benefit of Korean Patent Application No. 10-2016-0047047, filed Apr. 18, 2016, which is hereby incorporated by reference in its entirety into this application.

### BACKGROUND OF THE INVENTION

### 1. Technical Field

The present invention relates generally to technology for providing an advertisement and, more particularly, to an advertisement provision system capable of expanding the range of an advertisement using beacons installed in other membership stores in consideration of routes along which target users of a specific membership store move, an advertisement provision method using beacons based on the route along which users move, and an apparatus using the same.

### 2. Description of the Related Art

Currently, with the development of technology related to Internet of Things (IoT)-related services and the increased number of companies that launch businesses based on IoT, attention on and the use of IoT services are increasing.

Also, beacons based on Bluetooth Low Energy (BLE), having been developed by many companies, are being installed in various places, and various services using these beacons are being provided.

As one example of such services, beacons are installed in offline stores or public places, and services of the corresponding stores, such as discount coupons or the like, are provided to users who carry smartphones or mobile phones capable of sensing signals transmitted from the installed beacons.

However, the service based on beacons has a limited effect because the service is configured to merely provide a localized advertising service. In connection with this, Korean Patent Application Publication No. 10-2013-0089692 discloses a technology related to “Social networking system based on movement of user.”

### SUMMARY OF THE INVENTION

An object of the present invention is to provide an advertisement based on an expanded area using not only a beacon installed in a specific membership store for an advertisement but also beacons installed in multiple affiliate stores that have joined as members.

Another object of the present invention is to make respective beacons installed in multiple affiliate stores provide only advertisements that satisfy preset conditions, whereby a large number of unwanted advertisements is prevented from being provided.

A further object of the present invention is to provide an advertisement selected by the owner of a membership store, whereby an advertising effect for the corresponding membership store may be optimized.

Yet another object of the present invention is to provide an advertisement in consideration of the characteristics of each store and the movement of target users of the store, whereby a context-based advertisement service may be provided.

In order to accomplish the above objects, an advertisement provision server according to the present invention includes a beacon search unit for searching for multiple neighboring beacons located around a reference beacon installed in a membership store based on a location of the reference beacon; a target route acquisition unit for acquiring a target route corresponding to the membership store; an expanded range-based advertisement determination unit for determining whether an expanded range-based advertisement using a target beacon corresponding to the target route is capable of being provided; and an advertisement provision unit for providing an advertisement for the membership store using the target beacon when it is determined that the expanded range-based advertisement is capable of being provided.

Here, the advertisement provision server may further include a beacon recommendation unit for selecting at least some of the multiple neighboring beacons as beacons to be recommended in consideration of the target route, and the target beacon may be selected using the recommended beacons.

Here, the expanded range-based advertisement determination unit may check a condition for allowing an expanded range-based advertisement set for the target beacon, and may determine that the expanded range-based advertisement is capable of being provided only when the condition is satisfied.

Here, the condition for allowing an expanded range-based advertisement may include one or more of a condition related to a similarity of business types and a condition related to a number of expanded range-based advertisements.

Here, the expanded range-based advertisement determination unit may determine that the expanded range-based advertisement is not capable of being provided in any one of a case in which a similarity between a business type of the membership store and a business type of an affiliate store, in which the target beacon is installed, is equal to or greater than a preset reference similarity and a case in which the number of expanded range-based advertisements assigned to the target beacon is equal to or greater than a preset reference number.

Here, the target route acquisition unit may acquire the target route in consideration of a user condition corresponding to the membership store.

Here, the beacon recommendation unit may select the beacon to be recommended in consideration of a business type of the membership store.

Here, the beacon recommendation unit may store a result of an advertisement provided using the target beacon, and may select the beacon to be recommended in consideration of the result of the advertisement.

Also, a method for providing an advertisement according to the present invention includes searching for multiple neighboring beacons located around a reference beacon installed in a membership store based on a location of the reference beacon; acquiring a target route corresponding to the membership store; determining whether an expanded range-based advertisement using a target beacon corresponding to the target route is capable of being provided; and providing an advertisement for the membership store using the target beacon when it is determined that the expanded range-based advertisement is capable of being provided.

Here, the method may further include selecting at least some of the multiple neighboring beacons as beacons to be recommended in consideration of the target route, and the target beacon may be selected using the recommended beacons.

Here, determining whether the expanded range-based advertisement using the target beacon is capable of being provided may be configured to check a condition for allowing an expanded range-based advertisement set for the target beacon, and to determine that the expanded range-based advertisement is capable of being provided only when the condition is satisfied.

Here, the condition for allowing an expanded range-based advertisement may include one or more of a condition related to a similarity of business types and a condition related to a number of expanded range-based advertisements.

Here, determining whether the expanded range-based advertisement using the target beacon is capable of being provided may be configured to determine that the expanded range-based advertisement is not capable of being provided in any one of a case in which a similarity between a business type of the membership store and a business type of an affiliate store, in which the target beacon is installed, is equal to or greater than a preset reference similarity and a case in which the number of expanded range-based advertisements assigned to the target beacon is equal to or greater than a preset reference number.

Here, acquiring the target route may be configured to acquire the target route in consideration of a user condition corresponding to the membership store.

Here, selecting at least some of the multiple neighboring beacons as the beacons to be recommended may be configured to select the beacon to be recommended in consideration of a business type of the membership store.

Here, selecting at least some of the multiple neighboring beacons as the beacons to be recommended may be configured to store a result of an advertisement provided using the target beacon, and to select the beacon to be recommended in consideration of the result of the advertisement.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows a system for providing an advertisement according to an embodiment of the present invention;

FIG. 2 is a block diagram that shows an example of the advertisement provision server illustrated in FIG. 1;

FIG. 3 is a view that shows an example of multiple neighboring beacons according to the present invention;

FIG. 4 is a view that shows an example of a target route according to the present invention;

FIG. 5 is a view that shows an example of a target beacon according to the present invention;

FIG. 6 is a view that shows an example of a result of an advertisement provided using each target beacon according to the present invention;

FIG. 7 is a flowchart that shows a method for providing an advertisement according to an embodiment of the present invention;

FIG. 8 is a flowchart that specifically shows a method for providing an advertisement according to an embodiment of the present invention; and

FIG. 9 is a flowchart that shows the process of determining whether an advertisement based on an expanded range can be provided in a method for providing an advertisement according to an embodiment of the present invention.

### DESCRIPTION OF THE PREFERRED EMBODIMENTS

Hereinafter, a preferred embodiment of the present invention is described in detail with reference to the accompanying drawings. However, in the following description and the accompanying drawings, detailed descriptions of known functions and configurations deemed to make the gist of the present invention obscure will be omitted. Also, it should be understood that the same reference numerals are used to designate the same or similar elements throughout the drawings. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Terms or words used in this specification and in the claims should not be interpreted according to typical or dictionary meanings, but should be interpreted as having meanings and concepts adapted to the technical idea of the present invention based on the principle that an inventor may properly define the concept of the terms in order to explain the present invention in the best way. Therefore, embodiments disclosed in this specification and configurations illustrated in the drawings are merely preferred embodiments of the present invention and do not fully describe the technical idea of the present invention, and thus there may be various equivalents and alterations replacing them at the filing date of the present application. Also, it will be understood that, although the terms “first”, “second”, etc. may be used herein to describe various elements, these elements should not be limited by these terms. These terms are only used to distinguish one element from another.

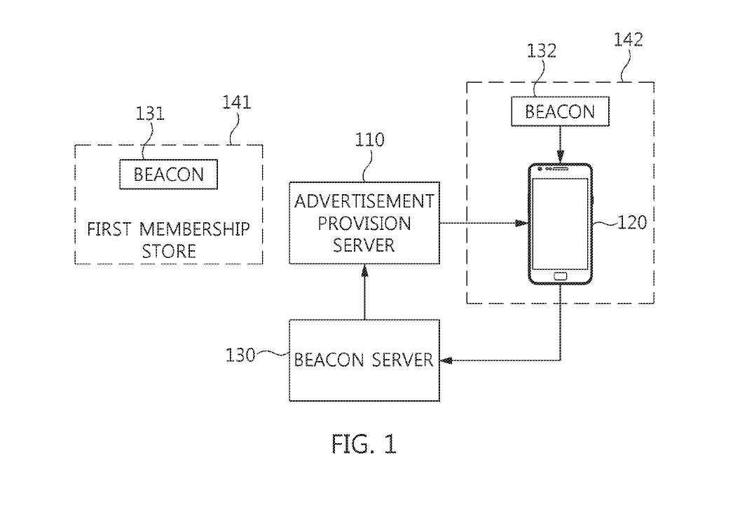

FIG. 1 is a block diagram that shows a system for providing an advertisement according to an embodiment of the present invention.

Referring to FIG. 1, a system for providing an advertisement according to an embodiment of the present invention includes an advertisement provision server 110, a terminal 120, a beacon server 130, and beacons 131 and 132 installed in membership stores 141 and 142.

The system for providing an advertisement according to an embodiment of the present invention may be intended to enable the owner of a store affiliated with a membership service to provide services, such as discount coupons, advertisements, and the like, using beacons of other affiliate stores located near the store. Accordingly, in order to establish an affiliation with a membership service according to an embodiment of the present invention, the owner of a store is required to install a beacon in his or her store and to approve of the provision of advertisements using the beacon.

Here, the owner of the store may check content related to the membership service on the web, and may make a request to join the membership service by inputting information necessary therefor, in order to establish an affiliation with the membership service. Here, the owner may input information about a beacon for the membership service, or may make a request for the installation of a beacon.

Also, an advertisement or a coupon to be provided to users may be created using a membership service. For example, when an advertiser inputs information, such as a discounted rate, an expiration date, and the like, on the web, the advertisement provision server may automatically create an advertisement or a coupon using a template based on the input information, and may provide it to users.

Here, the advertisement or the coupon may be provided to the terminal of a user through a push message or a Multimedia Messaging Service (MMS) using a special membership service application.

The advertisement provision server 110 searches for multiple neighboring beacons located near a reference beacon installed in a membership store based on the location of the reference beacon. For example, assuming that the beacon 131 of the membership store 141, illustrated in FIG. 1, is a reference beacon, the beacon 132 of the membership store 142 located near the reference beacon may become a neighboring beacon.

Also, the advertisement provision server 110 acquires a target route for a membership store.

Here, the target route may be acquired in consideration of user conditions corresponding to the membership store.

Here, the user conditions may correspond to conditions for limiting the main customers to whom an advertisement is to be provided by the membership store. For example, when a membership store is a cosmetics store for women, the user conditions may be set to ‘women’ so that an advertisement can be provided only to female customers. Also, the route along which many women move may be acquired as a target route.

Also, the advertisement provision server 110 selects at least some of the multiple neighboring beacons as the beacons to be recommended in consideration of the target route. For example, when a target route is included in the signal coverage area of the beacon 132 installed in the membership store 142, the beacon 132 may be selected as the beacon to be recommended.

Here, the beacon to be recommended may be selected in consideration of the business type of a membership store. For example, assuming that a membership store is ‘A convenience store’, it is inappropriate for the beacon installed in B convenience store to be used to provide an advertisement for A convenience store. Therefore, the beacon to be recommended may be selected in consideration of the business type of the membership store 141 in which a reference beacon is installed and the business type of the membership store 142 in which the beacon through which the advertisement is to be provided is installed.

Here, the result of an advertisement provided using a target beacon is stored, and the beacon to be recommended may be selected in consideration of the result of the advertisement.

Also, the advertisement provision server 110 determines whether an advertisement based on an expanded range can be provided using a target beacon corresponding to a target route.

Here, the target beacon may be selected using the recommended beacon.

Here, the target beacon may be selected by an advertiser who intends to provide an advertisement. Therefore, when information about multiple neighboring beacons is provided to the advertiser, if information about the beacons recommended based on a target route is also provided, the advertiser may select a target beacon based on the recommended beacons.

Here, a condition set on a target beacon in order to determine whether to allow an expanded range-based advertisement is checked, and it is determined that the expanded range-based advertisement can be provided only when the condition is satisfied.

Here, the condition for an expanded range-based advertisement may include one or more of a condition related to the similarity between business types and a condition related to the number of expanded range-based advertisements.

Here, when the similarity between the business type of a membership store and the business type of an affiliate store in which a target beacon is installed is equal to or greater than a preset reference similarity, or when the number of expanded range-based advertisements assigned to the target beacon is equal to or greater than a preset reference number, it is determined that the expanded range-based advertisement cannot be provided.

Also, when it is determined that the expanded range-based advertisement can be provided, the advertisement provision server 110 provides an advertisement for the membership store using the target beacon.

The terminal 120 may receive advertisements for the membership stores 141 and 142, and may provide them to users.

Also, the terminal 120 is a device on which a membership application can run by being connected to a communication network, and may be one of various terminals such as all data communication devices, multimedia terminals, Internet Protocol (IP) terminals, and the like, without limitation to a mobile communication terminal. Also, the terminal 120 may be a mobile terminal having various mobile communication capabilities, such as a mobile phone, a Portable Multimedia Player (PMP), a Mobile Internet Device (MID), a smartphone, a tablet PC, a notebook computer, a netbook, a Personal Digital Assistant (PDA), a smart TV, a data communication device, and the like.

Also, the terminal 120 may deliver various kinds of information input by a user, such as numbers, characters, and the like, and signals that are input in order to set and control various functions of the terminal 120 to a control unit via an input unit. Here, the input unit of the terminal 120 may be configured to include at least one of a keypad and a touch pad, which generate an input signal in response to touch or manipulation by a user. Here, the input unit of the terminal 120 may be configured in the form of a single touch panel (or a touch screen) by being integrated with a display unit thereof, whereby input and display functions may be performed through a single unit. Also, in addition to input devices such as a keyboard, a keypad, a mouse, a joystick, and the like, all forms of input units that have yet to be developed may be used as the input unit of the terminal 120. Particularly, the input unit of the terminal 120 according to the present invention may deliver a signal, input in order to join a membership service, to the control unit of the terminal 120.

Also, the display unit of the terminal 120 may display information about states and results of operations while the functions of the terminal 120 are being performed. Also, the display unit of the terminal 120 may display the menu items of the terminal 120, user data input by a user, and the like. Here, the display unit of the terminal 120 may be configured as a Liquid Crystal Display (LCD), a Thin Film Transistor LCD (TFT-LCD), a Light-Emitting Diode (LED), an Organic LED (OLED), an Active Matrix OLED (AMOLED), a retina display, a flexible display, a 3-dimensional display, or the like. Here, when the display unit of the terminal 120 is configured in the form of a touch screen, the display unit of the terminal 120 may perform some or all of the functions of the input unit of the terminal 120. Particularly, the display unit of the terminal 120 according to the present invention may display information related to processing of a membership service and a membership advertisement on the screen.

Also, a storage unit of the terminal 120, which is a device for storing data, may include a main memory device and an auxiliary memory device, and may store applications required for performing the functions of the terminal 120. The storage unit of the terminal 120 may include a program area and a data area. Here, when a function is enabled in response to a request from a user, the terminal 120 provides the function by running a corresponding application under the control of the control unit. Particularly, the storage unit of the terminal 120 according to the present invention may store an operating system (OS) related to the process of booting the terminal 120, a membership application, and the like. Also, the storage unit of the terminal 120 may store a content DB, in which multiple pieces of content are stored, and information about the terminal 120. Here, the content DB contains executable data for executing content, attribute information about the content, information about the use of the content in connection with the execution of the content, and the like. Also, the information about the terminal 120 may include the specifications of the terminal.

Also, a communication unit of the terminal 120 may perform a function for sending and receiving data to and from the advertisement provision server 110 via a network. Here, the communication unit of the terminal 120 may include an RF transmission means for performing up-conversion and amplification of the frequency of the signal to be transmitted and an RF reception means for performing low-noise amplification on a received signal and performing down-conversion on the frequency of the received signal. The communication unit of the terminal 120 may include at least one of a wireless communication module and a wired communication module. Here, the wireless communication module is a component for sending and receiving data according to a wireless communication method. When the terminal 120 uses wireless communication, the terminal 120 may send and receive data to and from the advertisement provision server 110 using any one of a wireless network communication module, a wireless LAN communication module, and a wireless PAN communication module. That is, the terminal 120 may access a network using the wireless communication module, and may send and receive data to and from the advertisement provision server 110 via the network. Particularly, the network according to the present invention enables the advertisement provision server 110 and the terminal 120 to communicate with each other, whereby they may send and receive advertising content of the membership stores 141 and 142.

Also, the control unit of the terminal 120 may be a processing device for running an OS and operating respective components. For example, the control unit may control the overall process of accessing the advertisement provision server 110. When the advertisement provision server 110 is accessed through a special service application, the control unit may control the process of running the application in response to a request from a user, and may send a request to use a service to the advertisement provision server 110 when running the application. In this case, the control unit may perform control so that information required for user authentication is sent along with the request to use the service.

Also, the control unit of the terminal 120 may execute specific content stored in the storage unit of the terminal 120 in response to a request from a user. Here, when the content is executed, the control unit may store the record on the use of the content as content usage information.

The beacon server 130 receives, from the terminal 120, an acknowledgement for the reception of a signal from a beacon 132 and provides the information received along with the acknowledgement to the advertisement provision server 110.

For example, when the terminal 120 enters a membership store 142, the terminal 120 may receive a beacon signal transmitted from a beacon 132. Then, the terminal 120 may inform the beacon server 130 of the reception of the beacon signal, in which case the identification information of the beacon 132 and advertisement information included in the beacon signal may be sent to the beacon server 130. Then, the beacon server 130 may deliver the received identification information of the beacon 132, the advertisement information, the identification information of the terminal 120, and the like to the advertisement provision server 110. Accordingly, the advertisement provision server 110 may provide an advertisement to the terminal 120 using the received information.

Here, the beacon 131 or 132 is a device used to provide various application services based on Bluetooth Low Energy (BLE), such as recognition of objects and situations, content push, indoor localization, automatic check-in, geo-fencing, and the like, and may periodically transmit a signal from the location at which the beacon 131 or 132 is installed. Such a beacon 131 or 132 may be classified into a sound-based low-frequency beacon, an LED beacon, a Wi-Fi beacon, a Bluetooth beacon, and the like, based on the method in which signals are transmitted. Also, a beacon may periodically transmit a signal using a small-sized packet, which is about 21 bytes, without the need to pair with a target device for receiving the signal, and may transmit a signal, which corresponds to the ID value of the beacon transmitter and received signal strength, over distances of up to 50 m, even though it operates with low power. Also, because such a beacon is small and inexpensive, it is easily fixed anywhere. Therefore, the beacon may be freely used anywhere in the offline store.

Also, although not illustrated in FIG. 1, the system for providing an advertisement according to an embodiment of the present invention may include a network. Here, the network provides a route through which data may be exchanged between the advertisement provision server 110, the terminal 120, and the beacon server 130, and may be conceptually understood as including networks that are currently being used and networks that have yet to be developed. For example, the network may be any one of wired and wireless local area networks for providing communication between various kinds of data devices in a limited area, a mobile communication network for providing communication between mobile devices or between a mobile device and the outside thereof, a satellite network for providing communication between earth stations using a satellite, and a wired and wireless communication network, or may be a combination of two or more selected therefrom. Meanwhile, a transmission protocol standard for the network is not limited to existing transmission protocol standards, but may include all transmission protocol standards to be developed in the future. Also, in FIG. 1, the network used between the advertisement provision server 110 and the terminal 120 may differ from the network used between the terminal 120 and the beacon server 130, but may be identical to the network used between the terminal 120 and the beacon server 130.

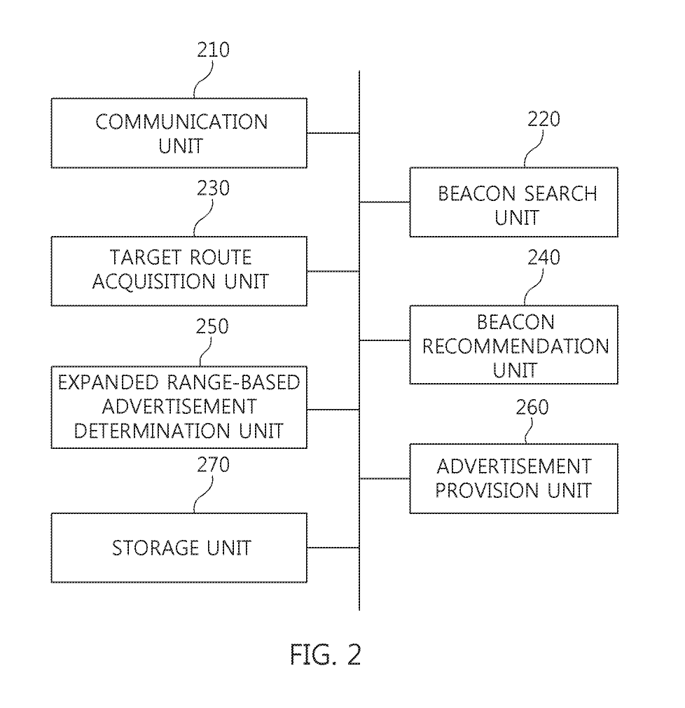

FIG. 2 is a block diagram that shows an example of the advertisement provision server illustrated in FIG. 1.

Referring to FIG. 2, the advertisement provision server 110 illustrated in FIG. 1 includes a communication unit 210, a beacon search unit 220, a target route acquisition unit 230, a beacon recommendation unit 240, an expanded range-based advertisement determination unit 250, an advertisement provision unit 260, and a storage unit 270.

The communication unit 210 serves to send and receive information necessary to provide an advertisement to and from the terminal of a user and the beacon server via the network. Particularly, the communication unit 210 according to an embodiment of the present invention may receive, from the beacon server, the information about the terminal that received a beacon signal, and may provide an advertisement and advertising content to the terminal of the user.

The beacon search unit 220 searches for multiple neighboring beacons located in the vicinity of a reference beacon installed in a membership store based on the location of the reference beacon.

Here, the membership store may be an offline store affiliated with a membership service for providing an advertisement according to an embodiment of the present invention. Here, the membership store may be necessarily required to install at least one beacon therein when the store is affiliated with the membership service.

Here, the present invention intends to provide an advertisement for an advertiser's store in a broader area using beacons installed in other membership stores, rather than using only the beacon installed in the advertiser's store. Accordingly, the beacon installed in the membership store corresponding to the advertiser's store is set as a reference beacon, and multiple membership stores within a certain area set based on the location of the reference beacon are searched for. Then, beacons installed in the found stores are set as multiple neighboring beacons. That is, the multiple neighboring beacons may be located within the certain area set based on the location of the reference beacon.

Here, the certain area may correspond to the business area of the membership store. If users located far away from the membership store receive an advertisement for the membership store, because the users are less likely to visit the membership store due to the distance, beacons in the business area in which the membership store is more likely to be used may be searched for.

Here, the beacon may be a device for acquiring user information in order to provide an advertisement thereto by detecting the location of a user by transmitting a signal to the terminal of the user within the signal coverage area of the beacon. For example, if a beacon is installed in the area in which an advertisement is to be provided, the terminals of users who are passing through or staying in the area receive a signal from the beacon, whereby the location of the users may be detected. Accordingly, the advertisement provision server may detect that the users are located in the area in which an advertisement can be provided, and may provide the advertisement to the terminals of the users.

Therefore, a special application for performing operations, such as transmitting a beacon signal to the beacon server, receiving an advertisement from the advertisement provision server, and the like, may be installed in the terminal of the user.

In this case, the present invention may be extensively applied in virtual regions using information acquired from a GPS, Wi-Fi, and the like, as well as physical beacons based on BLE.

The target route acquisition unit 230 acquires a target route corresponding to the membership store.

Here, the target route may be a route along which the main users, who are the main customers of a membership store, move. Here, information about routes along which respective users move is collected based on user information, and the target route may be acquired based on the statistics of the acquired routes.

Here, the target route may be acquired in consideration of user conditions corresponding to the membership store.

Here, the user conditions may be conditions for limiting the users who will receive an advertisement provided by a membership store. For example, if the user conditions are set to ‘men in their twenties’, only users who are men in their twenties can receive the advertisement provided by the membership store, among the multiple users who have joined the membership service.

Therefore, based on information about the target users who satisfy the user conditions, among the users registered in the advertisement provision server, information about the routes along which the target users move is acquired, and more frequently used routes are collected, whereby the target route may be acquired.

Here, the user conditions may be generated according to the sex or age of users, and other user conditions may be generated according to the time of day or the day of the week.

For example, if user conditions are set depending on whether the current day is a weekday or falls on the weekend, target routes respectively corresponding to a weekend and a weekday may be acquired.

In another example, if user conditions are set based on the meal time or the time when people leave work during the day, target routes may be acquired based on the user conditions corresponding to the meal time and the time at which people leave work.

The beacon recommendation unit 240 selects at least some of the multiple neighboring beacons as beacons to be recommended in consideration of the target route.

Here, the beacon recommendation unit 240 checks the signal coverage area of each of the multiple neighboring beacons, and may then select a beacon, the signal coverage area of which includes the target route, as the beacon to be recommended. That is, the beacon that can transmit its beacon signal to the terminal of the user who is moving along the target route may be selected as the beacon to be recommended.

Here, the beacon to be recommended may be selected in consideration of the business type of a membership store. For example, if the membership store A, which wants to provide an advertisement, is a children's clothing store, it may be inappropriate for another children's clothing store of the same brand or another children's clothing store, among the other membership stores located near the membership store A, to provide the advertisement for the membership store A. Therefore, the beacon to be recommended may be selected after checking the business type of the membership store in which the corresponding beacon is installed.

Here, the result of an advertisement provided using a target beacon is stored, and the beacon to be recommended may be selected in consideration of the result.

For example, assume that the beacon B, which is one of the beacons neighboring the membership store A, is set as a target beacon, and that an advertisement is provided to women in their twenties using the target beacon. In this case, the result of the advertisement for the membership store A, which was provided using the beacon B, may be stored.

Then, when the membership store C searches for neighboring beacons to be used to provide an advertisement to women in their twenties, if the beacon B is included in the found beacons, the beacon B may be selected as the beacon to be recommended based on the information stored as the result of the advertisement for the membership store A.

Here, if the result of the advertisement for the membership store A, provided using the beacon B, was not good, the beacon B may not be selected as the beacon to be recommended for the membership store C.

Conversely, if the result of the advertisement for the membership store A, provided using the beacon B, was good, the beacon B may be selected as the beacon to be recommended for the membership store C.

The expanded range-based advertisement determination unit 250 determines whether an expanded range-based advertisement using a target beacon corresponding to the target route can be provided.

Here, the expanded range-based advertisement may indicate an advertisement provided to the terminals of users based on beacons installed in other membership stores, rather than the membership store corresponding to the advertisement. That is, an advertisement for an advertiser's store may be provided not only in the advertiser's store but also in other stores in which a target beacon is installed.

However, if advertisements for multiple stores are provided all together through a beacon in a single store, when a user visits the store, unnecessary information or an excessive number of unwanted advertisements may be provided to the terminal of the user. Therefore, the present invention may determine whether each of the beacons installed in multiple membership stores can provide an expanded range-based advertisement, after which each of the beacons may provide the advertisement.

Here, the target beacon may be set using the recommended beacon. For example, when the advertisement provision server presents one or more recommended beacons to an advertiser, the advertiser may set some of them as target beacons for providing an advertisement. Alternatively, the advertiser may set all of them as target beacons.

Here, a condition for allowing an expanded range-based advertisement, which is set for each of the target beacons, is checked, and when the condition is satisfied, the expanded range-based advertisement may be provided.

Here, the condition for allowing an expanded range-based advertisement may be a condition set in order to determine whether the corresponding advertisement can be provided using a target beacon. That is, when an advertisement does not satisfy the condition for an expanded range-based advertisement set for the target beacon, the advertisement may not be provided using the target beacon.

Here, the condition for allowing an expanded range-based advertisement may include one or more of a condition related to the similarity of the business types and a condition related to the number of expanded range-based advertisements. For example, an expanded range-based advertisement may be provided when the business type of the membership store that intends to provide an advertisement therefor is not similar to the business type of the membership store in which a target beacon to be used to transmit the advertisement is installed. Also, the number of expanded range-based advertisements that can be provided using a target beacon is preset, and if the target beacon already provides the preset number of expanded range-based advertisements, an additional expanded range-based advertisement cannot be provided using the target beacon.

In this case, when the similarity between the business type of the membership store that intends to provide an advertisement therefor and the business type of the membership store in which a target beacon is installed is equal to or greater than a preset reference similarity, or when the number of expanded range-based advertisements already assigned to the target beacon is equal to or greater than a preset reference number, it is determined that an expanded range-based advertisement cannot be provided.

For example, the similarity of the business type may be calculated by comparing information about the business type of the membership store that intends to provide an advertisement therefor, which includes the name, the type, the shape and the price of products being sold therein, with that of the membership store in which a target beacon is installed. If the preset reference similarity is 70%, when the calculated similarity of the business type is less than 70%, it is determined that an expanded range-based advertisement can be provided.

In another example, when the number of expanded range-based advertisements currently assigned to the target beacon is 10 and when the preset reference number is also 10, because it is impossible to additionally assign an expanded range-based advertisement to the target beacon, it is determined that the expanded range-based advertisement cannot be provided.

The advertisement provision unit 260 provides an advertisement corresponding to a membership store using a target beacon when it is determined that an expanded range-based advertisement can be provided.

In other words, when a user enters the signal coverage area of the target beacon, the advertisement corresponding to a membership store may be provided by transmitting a beacon signal to the terminal of the user. Here, the advertisement may be provided only when the user satisfies the user conditions corresponding to the membership store.

The storage unit 270 stores various kinds of information generated during the above-mentioned process for providing an advertisement according to an embodiment of the present invention.

According to an embodiment, the storage unit 270 may be configured to be separate from the advertisement provision server 110 and to support a function for providing an advertisement. Here, the storage unit 270 may operate as separate mass storage, and may include a control function for performing operations.

Meanwhile, the advertisement provision server 110 may include memory, and information may be stored therein. In an embodiment, the memory is a computer-readable recording medium. The memory may be a volatile memory unit in an embodiment, or the memory may be a non-volatile memory unit in another embodiment. In an embodiment, a storage device is a computer-readable recording medium. In different embodiments, the storage device may include, for example, a hard disk device, an optical disk device, or any other kind of mass storage device.

Using the above-described advertisement provision server, an advertisement based on an expanded range may be provided using not only a beacon installed in a specific membership store that intends to provide an advertisement but also beacons installed in other affiliate stores, which have joined as members.

Also, because respective beacons installed in multiple affiliate stores provide only advertisements that satisfy preset conditions, an excessive number of unwanted advertisements is prevented from being provided.

Also, because an advertisement selected by the owner of a membership store is provided, the effect of the advertisement for the membership store may be optimized.

Also, because an advertisement is provided in consideration of the characteristics of each store and the route along which the main users of the store move, a context-based advertisement service may be provided.

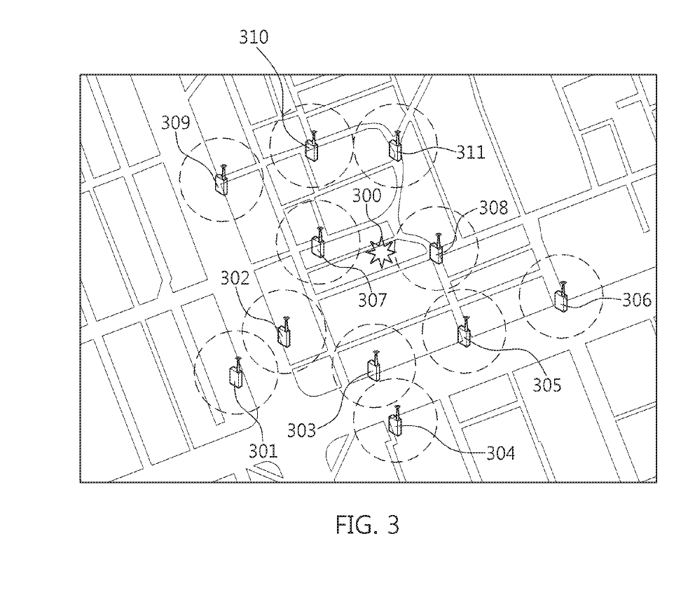

FIG. 3 is a view that shows an example of multiple neighboring beacons according to the present invention.

Referring to FIG. 3, multiple neighboring beacons 301 to 311 according to the present invention may be installed in different membership stores located around the membership store 300 that intends to provide an advertisement therefor.

Here, the multiple neighboring beacons 301 to 311 may be installed in different membership stores that are located within a certain range based on the location of a reference beacon installed in the membership store 300.

That is, referring to FIG. 3, the multiple neighboring beacons 301 to 311 may be located in respective ones of the membership stores.

Here, each of the multiple neighboring beacons 301 to 311 may have the signal coverage shown in FIG. 3. Accordingly, when a certain user enters the signal coverage area of each of the multiple neighboring beacons 301 to 311, an advertisement provision server may detect the location of the user.

For example, when user ‘A’, who carries a terminal, enters the signal coverage area of the beacon 301, marked with the circle in the dotted line in FIG. 3, the terminal may receive a beacon signal from the beacon 301. Here, the terminal that received the beacon signal from the beacon 301 sends an acknowledgement to a beacon server, and the beacon server provides the corresponding information to the advertisement provision server, whereby the advertisement provision server may detect that user ‘A’ is located near the beacon 301.

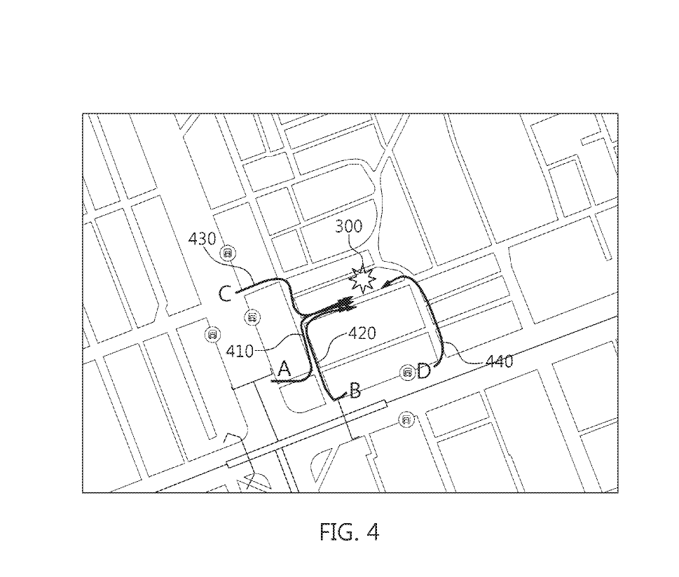

FIG. 4 is a view that shows an example of a target route according to the present invention.

Referring to FIG. 4, in order to acquire a target route according to the present invention, first, the route along which target users move may be acquired from an apparatus for providing an advertisement based on user conditions corresponding to a membership store 300.

For example, assuming that the user conditions for the membership store 300 illustrated in FIG. 4 are ‘men in their twenties to forties’, user information about men in their twenties to forties may be acquired, among the multiple users registered in the apparatus for providing an advertisement.

Then, the routes around the membership store 300 are detected based on the acquired user information, whereby multiple routes may be acquired. Here, because there may be various acquired routes, a certain number of target routes 410 to 440 may be acquired based on the statistics of the acquired routes, as shown in FIG. 4.

Here, the user conditions corresponding to the membership store may be generated according to the sex or age of the user.

Also, different user conditions may be generated according to the day of the week or the time of day, even for a single membership store. Accordingly, the target routes may be generated so as to correspond to different user conditions according to the day of the week or the time of day.

For example, assuming that the membership store 300 illustrated in FIG. 4 has different user conditions depending on whether or not the current day is a weekday, only the target route A 410 and the target route D 440 are acquired on weekdays so as to satisfy the separate user conditions, but all of the target routes from the target route A 410 to the target route D 440 may be acquired on the weekend because a lot of people move around on the weekend.

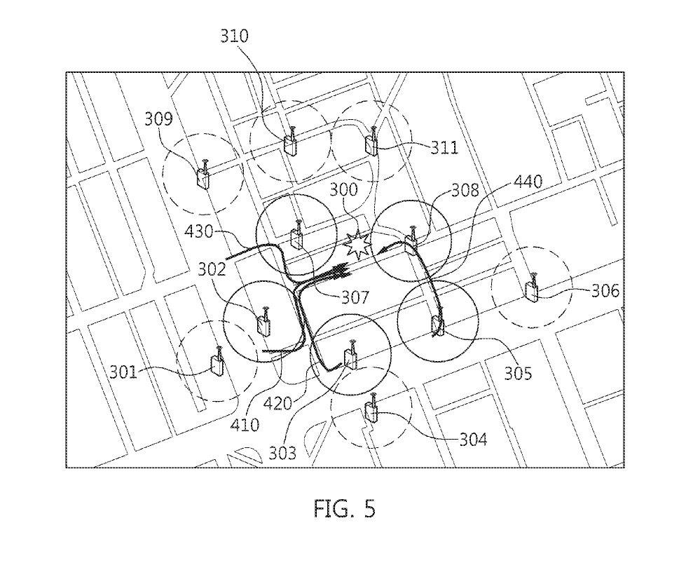

FIG. 5 is a view that shows an example of a target beacon according to the present invention.

Referring to FIG. 5, target beacons according to the present invention may be some of the multiple neighboring beacons 301 to 311 of the membership store 300.

Here, an advertisement provision server may select the beacon to be recommended to an advertiser based on the target routes 410 to 440.

For example, there may be target routes 410 to 440 corresponding to the membership store 300, as shown in FIG. 5. Here, the beacons 302, 303, 305, 307 and 308, the signal coverage area of which includes the target routes 410 to 440, may be selected from among the multiple neighboring beacons 301 to 311 of the membership store 300, and the selected beacons may be recommended.

Then, the advertiser may finally select target beacons for providing an advertisement from among the recommended beacons 302, 303, 305, 307 and 308.

Here, some of the beacons 302, 303, 305, 307 and 308 may be selected as target beacons, or alternatively all of the beacons 302, 303, 305, 307 and 308 may be selected as target beacons.

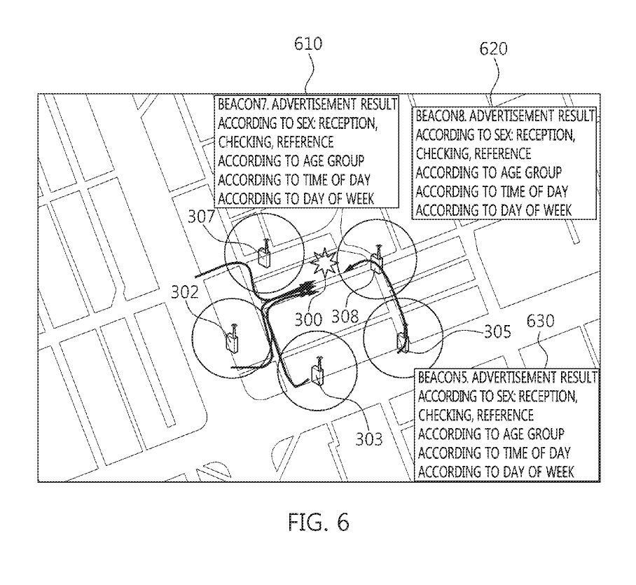

FIG. 6 is a view that shows an example of a result of an advertisement provided by each target beacon according to the present invention.

Referring to FIG. 6, the advertisement results 610 to 630 provided by respective target beacons according to the present invention may be stored based on the sex or age of the users who received an advertisement provided from the corresponding beacon, the time of day or the day of the week on which the advertisement was provided, or the like.

For example, when an advertisement for the membership store 300 is provided to men and women, the advertisement results 610 to 630 may be retrieved respectively for men and women according to the sex of the users who received the advertisement. That is, information, such as how many men and women received the advertisement for the membership store 300, how many men and women used the membership store 300 after receiving the advertisement, and the like, may be acquired.

In another example, when an advertisement for the membership store 300 is provided to all users regardless of the age of the users, the advertisement results 610 to 630, separated according to the age group of the users who received the advertisement, may be retrieved. That is, information, such as how many users in their teens, twenties, thirties, forties, and other age groups respectively received the advertisement for the membership store 300, how many users in the respective age groups used the membership store 300 after viewing the advertisement, and the like, may be acquired.

In another example, information about the provision of an advertisement according to time blocks may be acquired. That is, assuming that a time block is set every two hours during the day, the number of users to whom the advertisement was provided in each time block may be checked. Also, information about how many users viewed the advertisement and visited the membership store 300 in each time block may also be checked.

In another example, information about the provision of an advertisement for the membership store 300 according to the day of the week may be acquired, similar to the example of the provision of an advertisement according to time blocks. That is, depending on whether the current day is a weekday or falls on the weekend, the number of users to whom the advertisement is provided on the weekend and the number of users to whom the advertisement is provided on weekdays may be checked. Also, information, such as the number of users who received the advertisement and used the membership store 300 respectively on the weekend and on weekdays may be checked.

Therefore, when it is necessary to recommend beacons 302, 303, 305, 307 and 308 to an advertiser, the beacons to be recommended may be selected using the advertisement results 610 to 630 stored as shown in FIG. 6.

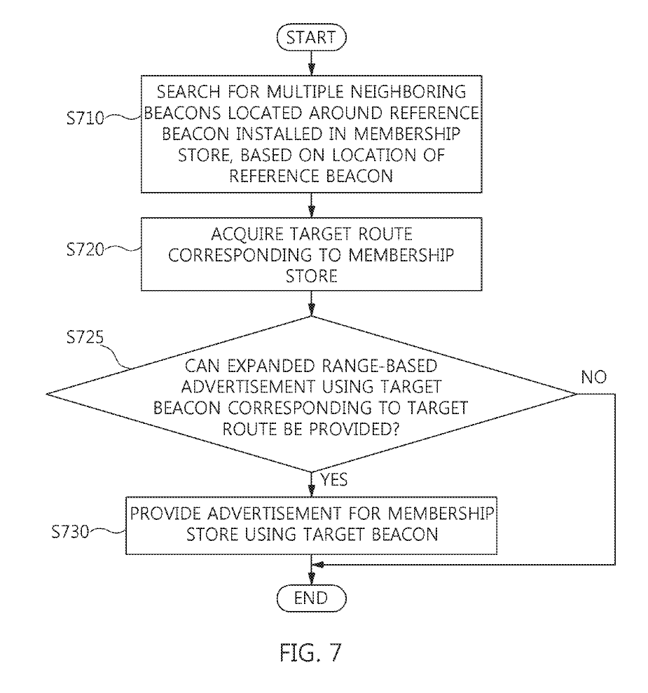

FIG. 7 is a flowchart that shows a method for providing an advertisement according to an embodiment of the present invention.

Referring to FIG. 7, in the method for providing an advertisement according to an embodiment of the present invention, multiple neighboring beacons located near a reference beacon installed in a membership store are searched for at step S710 based on the location of the reference beacon.

Here, the membership store may be an offline store affiliated with a membership service for providing an advertisement according to an embodiment of the present invention. Here, the membership store may be necessarily required to install at least one beacon therein when the store is affiliated with the membership service.

Here, the present invention intends to provide an advertisement for an advertiser's store in a broader area using beacons installed in other membership stores, rather than using only the beacon installed in the advertiser's store. Accordingly, the beacon installed in the membership store corresponding to the advertiser's store is set as a reference beacon, and multiple membership stores within a certain area set based on the location of the reference beacon are searched for. Then, beacons installed in the found stores are set as multiple neighboring beacons. That is, the multiple neighboring beacons may be located within the certain area set based on the location of the reference beacon.

Here, the certain area may correspond to the business area of the membership store. If users located far away from the membership store receive an advertisement for the membership store, because the users are less likely to visit the membership store due to the distance, beacons located in the business area in which the membership store is more likely to be used may be searched for.

Here, the beacon may be a device for acquiring user information in order to provide an advertisement thereto by detecting the location of a user by transmitting a signal to the terminal of the user within the signal coverage area of the beacon. For example, if a beacon is installed in the area in which an advertisement is to be provided, the terminals of users who are passing through or staying in the area receive a signal from the beacon, whereby the location of the users may be detected. Accordingly, the advertisement provision server may detect that the users are located in the area in which an advertisement can be provided, and may provide the advertisement to the terminals of the users.

Therefore, a special application for performing operations, such as transmitting a beacon signal to the beacon server, receiving an advertisement from the advertisement provision server, and the like, may be installed in the terminal of the user.

In this case, the present invention may be extensively applied in virtual regions using information acquired from a GPS, Wi-Fi, and the like, as well as physical beacons based on BLE.

Also, in the method for providing an advertisement according to an embodiment of the present invention, a target route corresponding to the membership store is acquired at step S720.

Here, the target route may be a route along which the main users, who are the main customers of a membership store, move. Here, information about routes along which respective users move is collected based on user information, and the target route may be acquired based on the statistics of the acquired routes.

Here, the target route may be acquired in consideration of user conditions corresponding to the membership store.

Here, the user conditions may be conditions for limiting the users who will receive an advertisement provided by a membership store. For example, if the user conditions are set to ‘men in their twenties’, only users who are men in their twenties can receive the advertisement provided by the membership store, among the multiple users who have joined the membership service.

Therefore, based on information about the target users who satisfy the user conditions, among the users registered in the advertisement provision server, information about the routes along which the target users move is acquired, and more frequently used routes are collected, whereby the target route may be acquired.

Here, the user conditions may be generated according to the sex or age of users, and other user conditions may be generated according to the time of day or the day of the week.

For example, if user conditions are set depending on whether the current day is a weekday or falls on the weekend, target routes respectively corresponding to a weekend and a weekday may be acquired.

In another example, if user conditions are set based on meal times or the time when people leave work during the day, target routes may be acquired based on the user conditions corresponding to the meal time and the time at which people leave work.

Also, although not illustrated in FIG. 7, in the method for providing an advertisement according to an embodiment of the present invention, at least some of the multiple neighboring beacons are selected as the beacons to be recommended in consideration of the target route.

Here, the signal coverage area of each of the multiple neighboring beacons is checked, and a beacon, the signal coverage area of which includes the target route, may be selected as the beacon to be recommended. That is, the beacon that can transmit its beacon signal to the terminal of the user who is moving along the target route may be selected as the beacon to be recommended.

Here, the beacon to be recommended may be selected in consideration of the business type of the membership store. For example, if the membership store A, which wants to provide an advertisement, is a children's clothing store, it may be inappropriate for another children's clothing store of the same brand or another children's clothing store, among the other membership stores located near the membership store A, to provide the advertisement for the membership store A. Therefore, the beacon to be recommended may be selected after checking the business type of the membership store in which the corresponding beacon is installed.

Here, the result of an advertisement provided using a target beacon is stored, and the beacon to be recommended may be selected in consideration of the result.

For example, assume that the beacon B, which is one of the beacons neighboring the membership store A, is set as a target beacon, and that an advertisement is provided to women in their twenties using the target beacon. In this case, the result of the advertisement for the membership store A, which was provided using the beacon B, may be stored.

Then, when the membership store C searches for neighboring beacons to be used to provide an advertisement to women in their twenties, if the beacon B is included in the found beacons, the beacon B may be selected as the beacon to be recommended based on the information stored as the result of the advertisement for the membership store A.

Here, if the result of the advertisement for the membership store A, provided using the beacon B, was not good, the beacon B may not be selected as the beacon to be recommended for the membership store C.

Conversely, if the result of the advertisement for the membership store A, provided using the beacon B, was good, the beacon B may be selected as the beacon to be recommended for the membership store C.

Also, in the method for providing an advertisement according to an embodiment of the present invention, it is determined at step S725 whether an expanded range-based advertisement using a target beacon corresponding to the target route can be provided.

Here, the expanded range-based advertisement may indicate an advertisement provided to the terminals of users based on beacons installed in other membership stores rather than the membership store corresponding to the advertisement. That is, an advertisement for an advertiser's store may be provided not only in the advertiser's store but also in other stores in which a target beacon is installed.

However, if advertisements for multiple stores are provided all together through a beacon in a single store, when a user visits the store, unnecessary information or an excessive number of unwanted advertisements may be provided to the terminal of the user. Therefore, the present invention may determine whether each of the beacons installed in multiple membership stores can provide an expanded range-based advertisement, after which each of the beacons may provide the advertisement.

Here, the target beacon may be set using the recommended beacon. For example, when the advertisement provision server presents one or more recommended beacons to an advertiser, the advertiser may set some of them as target beacons for providing an advertisement. Here, the advertiser may set all of them as target beacons.

Here, a condition for allowing an expanded range-based advertisement, which is set for each of the target beacons, is checked, and when the condition is satisfied, the expanded range-based advertisement may be provided.

Here, the condition for allowing an expanded range-based advertisement may be a condition set in order to determine whether the corresponding advertisement can be provided using a target beacon. That is, when an advertisement does not satisfy the condition for an expanded range-based advertisement set for the target beacon, the advertisement may not be provided using the target beacon.

Here, the condition for allowing an expanded range-based advertisement may include one or more of a condition related to the similarity of the business types and a condition related to the number of expanded range-based advertisements. For example, an expanded range-based advertisement may be provided when the business type of the membership store that intends to provide an advertisement therefor is not similar to the business type of the membership store in which a target beacon to be used to transmit the advertisement is installed. Also, the number of expanded range-based advertisements that can be provided using a target beacon is preset, and if the target beacon already provides the preset number of expanded range-based advertisements, an additional expanded range-based advertisement cannot be provided using the target beacon.

In this case, when the similarity between the business type of the membership store that intends to provide an advertisement therefor and the business type of the membership store in which a target beacon is installed is equal to or greater than a preset reference similarity, or when the number of expanded range-based advertisements already assigned to the target beacon is equal to or greater than a preset reference number, it is determined that an expanded range-based advertisement cannot be provided.

For example, the similarity of the business type may be calculated by comparing information about the business type of the membership store that intends to provide an advertisement therefor, which includes the name, the type, the shape and the price of products being sold therein, with that of the membership store in which a target beacon is installed. If the preset reference similarity is 70%, when the calculated similarity of the business type is less than 70%, it is determined that an expanded range-based advertisement can be provided.

In another example, when the number of expanded range-based advertisements currently assigned to the target beacon is 10 and when the preset reference number is also 10, because it is impossible to additionally assign an expanded range-based advertisement to the target beacon, it is determined that the expanded range-based advertisement cannot be provided.

When it is determined at step S725 that the expanded range-based advertisement can be provided, the advertisement for the membership store is provided using the target beacon at step S730.

In other words, when a user enters the signal coverage area of the target beacon, the advertisement corresponding to a membership store may be provided by transmitting a beacon signal to the terminal of the user. Here, the advertisement may be provided only when the user satisfies the user conditions corresponding to the membership store.

Also, when it is determined at step S725 that the expanded range-based advertisement cannot be provided, the advertisement for the membership store may not be provided using the corresponding target beacon. Here, other target beacons are searched for, and the advertisement may be provided using the target beacons that can provide an expanded range-based advertisement.

Also, although not illustrated in FIG. 7, in the method for providing an advertisement according to an embodiment of the present invention, information necessary for providing an advertisement is sent and received between the advertisement provision server, the terminal of a user, and the beacon server using a network. Particularly, information about the terminal that received a beacon signal may be acquired from a beacon server, and an advertisement and advertising content may be provided to the terminal of the user.

Also, although not illustrated in FIG. 7, in the method for providing an advertisement according to an embodiment of the present invention, various kinds of information generated during the above-mentioned process for providing an advertisement according to an embodiment of the present invention is stored.

Through the above-described method for providing an advertisement, an advertisement based on an expanded range may be provided using not only a beacon installed in a specific membership store that intends to provide an advertisement but also beacons installed in other affiliate stores, which have joined as members.

Also, because respective beacons installed in multiple affiliate stores provide only advertisements that satisfy preset conditions, an excessive number of unwanted advertisements is prevented from being provided.

Also, because an advertisement selected by the owner of a membership store is provided, the effect of the advertisement for the membership store may be optimized.

Also, because an advertisement is provided in consideration of the characteristics of each store and the route along which the main users of the store move, a context-based advertisement service may be provided.

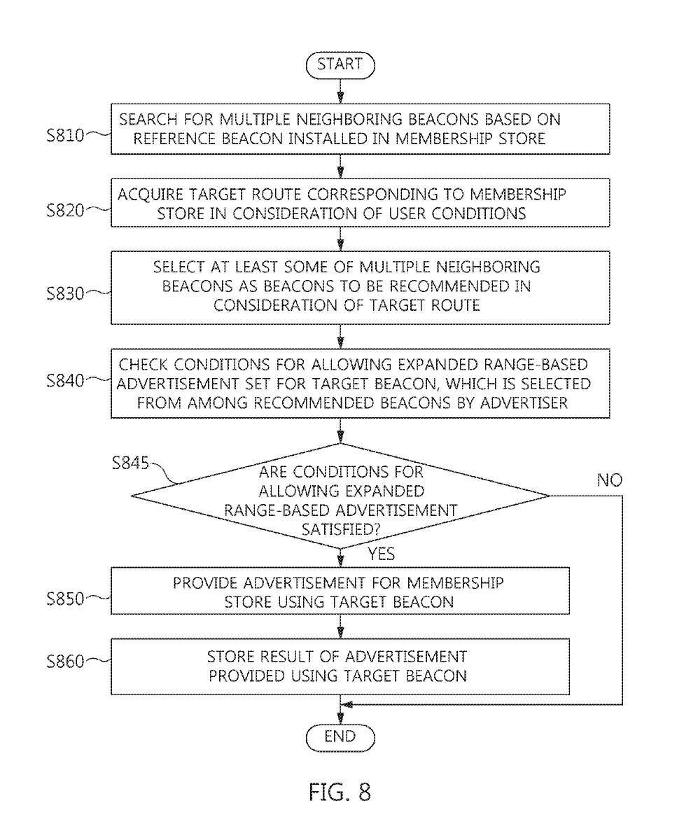

FIG. 8 is a flowchart that specifically shows a method for providing an advertisement according to an embodiment of the present invention.

Referring to FIG. 8, in the method for providing an advertisement according to an embodiment of the present invention, first, multiple neighboring beacons located near a reference beacon installed in a membership store are searched for at step S810 based on the location of the reference beacon.

Here, the multiple neighboring beacons may be located within a certain area based on the location of the reference beacon.

Here, the present invention may be extensively applied in virtual regions using information acquired from a GPS, Wi-Fi, and the like, as well as physical beacons based on BLE.

Then, a target route is acquired at step S820 in consideration of user conditions corresponding to the membership store.

Here, the user conditions may be conditions for limiting the users who will receive an advertisement provided by the membership store.

Here, the user conditions may be generated according to the sex or age of users, and other user conditions may be generated according to the time of day or the day of the week.

Then, at least some of the multiple neighboring beacons are selected as the beacons to be recommended in consideration of the target routes at step S830.

Here, the signal coverage area of each of the multiple neighboring beacons is checked, and a beacon, the signal coverage area of which includes the target route, may be selected as the beacon to be recommended.

Here, the beacon to be recommended may be selected in consideration of the business type of the membership store.

Here, the result of an advertisement provided using a target beacon is stored, and the beacon to be recommended may be selected in consideration of the result of the advertisement.

Then, it is determined at step S845 whether a condition for allowing an expanded range-based advertisement corresponding to a target beacon is satisfied.

Here, the expanded range-based advertisement may indicate an advertisement provided to the terminals of users based on beacons installed in other membership stores rather than the membership store corresponding to the advertisement.

Here, the condition for allowing an expanded range-based advertisement may be a condition set in order to determine whether the corresponding advertisement can be provided using the target beacon. That is, when an advertisement does not satisfy the condition for an expanded range-based advertisement set for the target beacon, the advertisement may not be provided using the target beacon.

Here, the condition for allowing an expanded range-based advertisement may include one or more of a condition related to the similarity of the business types and a condition related to the number of expanded range-based advertisements.

In this case, when the similarity between the business type of the membership store that intends to provide an advertisement therefor and the business type of the membership store in which the target beacon is installed is equal to or greater than a preset reference similarity, or when the number of expanded range-based advertisements already assigned to the target beacon is equal to or greater than a preset reference number, it is determined that an expanded range-based advertisement cannot be provided.

When it is determined at step S845 that the condition for allowing an expanded range-based advertisement is satisfied, the advertisement for the membership store is provided using the target beacon at step S850.

That is, when a user enters the signal coverage area of the target beacon, the advertisement corresponding to the membership store may be provided by transmitting a beacon signal to the terminal of the user.

Then, the result of the advertisement provided using the target beacon is stored at step S860.

Here, the result of the advertisement provided using the target beacon is stored, and the beacon to be recommended may be selected in consideration of the result of the advertisement.

For example, assume that the beacon B, which is one of the beacons neighboring the membership store A, is set as a target beacon, and that an advertisement is provided to women in their twenties using the target beacon. In this case, the result of the advertisement for the membership store A, which was provided using the beacon B, may be stored.

Then, when the membership store C searches for neighboring beacons to be used to provide an advertisement to women in their twenties, if the beacon B is included in the found beacons, the beacon B may be selected as the beacon to be recommended based on the information stored as the result of the advertisement for the membership store A.

Here, if the result of the advertisement for the membership store A, provided using the beacon B, was not good, the beacon B may not be selected as the beacon to be recommended for the membership store C.

Conversely, if the result of the advertisement for the membership store A, provided using the beacon B, was good, the beacon B may be selected as the beacon to be recommended for the membership store C.

Also, if it is determined at step S845 that the condition for allowing an expanded range-based advertisement is not satisfied, the advertisement for the membership store may not be provided using the corresponding target beacon.

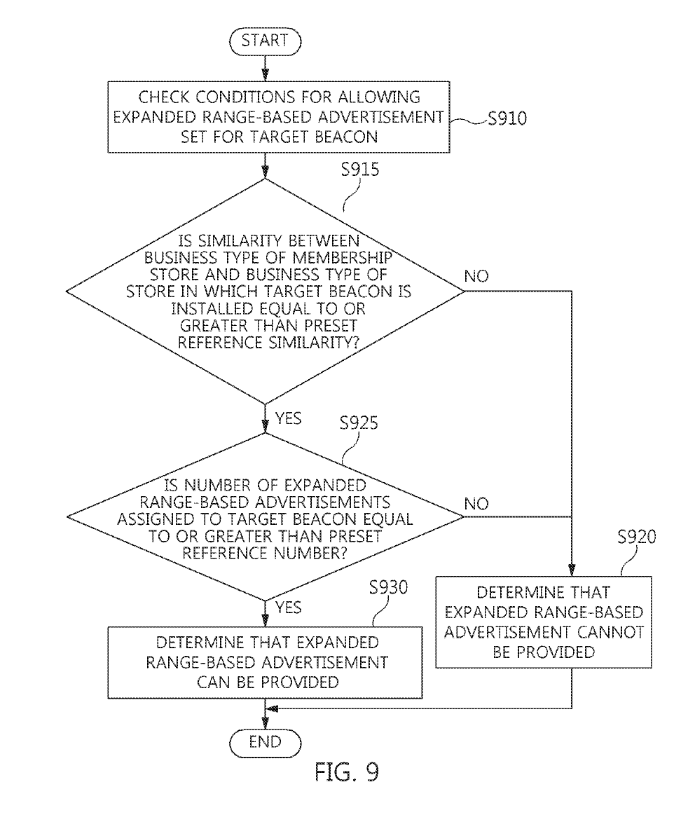

FIG. 9 is a flowchart that shows the process of determining whether an expanded range-based advertisement can be provided in the method for providing an advertisement according to an embodiment of the present invention.

Referring to FIG. 9, in the process of determining whether an expanded range-based advertisement can be provided in the method for providing an advertisement according to an embodiment of the present invention, first, a condition for allowing an expanded range-based advertisement for a target beacon is checked at step S910.

Then, it is determined at step S915 whether the similarity between the business type of the membership store that intends to provide an advertisement therefor and the business type of the membership store in which the target beacon is installed is equal to or greater than a preset reference similarity.

When it is determined at step S915 that the similarity of the business type is equal to or greater than the preset reference similarity, it is determined at step S920 that the expanded range-based advertisement cannot be provided by the target beacon.

Conversely, when it is determined at step S915 that the similarity of the business type is less than the preset reference similarity, it is determined at step S925 whether the number of expanded range-based advertisements already assigned to the target beacon is equal to or greater than a preset reference number.

When it is determined at step S925 that the number of expanded range-based advertisements is equal to or greater than the preset reference number, it is determined at step S920 that the expanded range-based advertisement cannot be provided by the target beacon.

Conversely, when it is determined at step S925 that the number of expanded range-based advertisements is less than the preset reference number, it is determined at step S930 that the expanded range-based advertisement can be provided by the target beacon.

Hitherto, those skilled in the art to which the present invention pertains may understand that the present invention may be implemented as other specific forms without changing the technical spirit and essential characteristics thereof. Accordingly, it should be understood that the above-described embodiments are illustrative and not restrictive in all aspects.

For example, the advertisement provision server or the terminal of a user according to the present invention may store information using memory. In an embodiment, the memory is a computer-readable storage medium. The memory may be a volatile memory unit in an embodiment, or the memory may be a non-volatile memory unit in another embodiment. Also, the memory may include, for example, a hard disk device, an optical disk device, or any other kind of mass storage device.

The advertisement provision server or the terminal of a user may also include one or more network interface devices, such as an Ethernet card, for example, a serial communication device such as an RS-232 port and/or a wireless interface device such as an 802.11 card, as an external input/output device. In another embodiment, this input/output device may include a driver device configured to send data output to another input/output device and receive data input therefrom, for example, a keyboard, a printer, a display device, and the like.

The advertisement provision server or the terminal of a user may be implemented using instructions that make one or more processing devices perform the above-described functions and processes. For example, such instructions may include interpretable instructions, such as script instructions, for example, JavaScript or ECMAScript, executable code, and other instructions stored in a computer-readable storage medium.

The advertisement provision server or the terminal of a user according to the present invention may be implemented on a single computer device or multiple computer devices distributed over a network, such as a server farm.

Embodiments of functional operations and subject matters described in this specification may be implemented in digital electronic circuitry, implemented in computer software, firmware, or hardware, which includes the structure disclosed herein and its structural equivalents, or may be implemented in a combination of one or more of these. Embodiments of the subject matter described in this specification may be implemented as one or more computer program products, that is, one or more modules related to computer program instructions encoded on a tangible program storage medium in order to control the operation of a processing system or to be run by the processing system.

The computer-readable storage medium may be a machine-readable storage device, a machine-readable storage board, a memory device, a composition of material having an influence on a machine-readable radio wave signal, or a combination of one or more of these.

In this specification, ‘system’ or ‘device’ encompasses all apparatuses, devices, and machines for processing data, which include, for example, a programmable processor, a computer, or multiple processors or computers. The processing system may include, in addition to hardware, code that creates an environment for executing a computer program in response to a request, for example, code that constitutes processor firmware, a protocol stack, a database management system, an operating system, or a combination of one or more of these.

A computer program (also known as a program, software, a software application, a script or code) may be written in any form of programming language, including complied or interpreted languages, and it may be deployed in any form, including as a stand-alone program or as a module, component, subroutine, or other unit suitable for use in a computing environment. A computer program does not necessarily correspond to a file in a file system. A program may be stored in a single file dedicated to a requested program, in multiple coordinated files (i.e., files that store one or more modules, sub-programs, or portions of code), or in a portion of a file that holds other programs or data (i.e., one or more scripts stored in a markup language document). A computer program may be deployed so as to be executed on a single computer or on multiple computers that are located at one site or distributed across multiple sites and interconnected via a communication network.

Meanwhile, a computer-readable storage medium suitable for storing computer program instructions and data may include all forms of non-volatile memory, media, and memory devices, for example, a semiconductor memory device, such as EPROM, EEPROM, and a flash memory device, a magnetic disk, such as an internal hard disk and an external disk, a magneto-optical disk, CD-ROM, DVD-ROM, and the like. The processor and memory may be complemented by a special-purpose logic circuit, or may be integrated thereto.

The method for providing an advertisement according to the present invention may be implemented as program instructions that can be executed by various computer means and recorded in a computer-readable storage medium. In this case, the program instructions recorded on the computer-readable storage medium may include program instructions, data files, and data structures, either solely or in combination. The program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as CD-ROM and a DVD, magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

According to the present invention, an advertisement based on an expanded area may be provided using not only a beacon installed in a specific membership store for an advertisement but also beacons installed in multiple affiliate stores that have joined as members.

Also, according to the present invention, respective beacons installed in multiple affiliate stores provide only advertisements that satisfy preset conditions, whereby an excessive number of unwanted advertisements may be prevented from being provided.

Also, according to the present invention, because an advertisement selected by the owner of a membership store is provided, an advertising effect for the corresponding membership store may be optimized.

Also, according to the present invention, an advertisement is effectively provided in consideration of the characteristics of each store and the movement of target users of the store, whereby a context-based advertisement service may be provided.

According to the present invention, multiple neighboring beacons located near a reference beacon installed in a membership store are searched for based on the location of the reference beacon, a target route corresponding to the membership store is acquired, whether an expanded range-based advertisement can be provided using a target beacons corresponding to the target route is checked, and an advertisement for the membership store may be provided using the target beacon when it is determined that the expanded range-based advertisement can be provided. Further, the owner of the membership store may provide an advertisement in a broader area without paying the expense for installing additional beacons, and the advertisement service provider may earn advertisement fees according to an advertising effect by providing an expanded range-based advertisement using the already installed beacons.

As described above, the advertisement provision system, a method for providing an advertisement using a beacon based on the movement of a user, and the apparatus using the same according to the present invention are not limitedly applied to the configurations and operations of the above-described embodiments, but all or some of the embodiments may be selectively combined and configured, so that the embodiments may be modified in various ways.

What is claimed is:

1. An advertisement provision server, comprising:
a beacon search unit for searching for multiple neighboring beacons located around a reference beacon installed in a membership store based on a location of the reference beacon;
a target route acquisition unit for acquiring a target route corresponding to the membership store;
an expanded range-based advertisement determination unit for determining whether an expanded range-based advertisement using a target beacon corresponding to the target route is capable of being provided; and
an advertisement provision unit for providing an advertisement for the membership store using the target beacon when it is determined that the expanded range-based advertisement is capable of being provided.

2. The advertisement provision server of claim 1, further comprising:
a beacon recommendation unit for selecting at least some of the multiple neighboring beacons as beacons to be recommended in consideration of the target route,
wherein the target beacon is selected using the recommended beacons.

3. The advertisement provision server of claim 1, wherein the expanded range-based advertisement determination unit checks a condition for allowing an expanded range-based advertisement set for the target beacon, and determines that the expanded range-based advertisement is capable of being provided only when the condition is satisfied.

4. The advertisement provision server of claim 3, wherein the condition for allowing an expanded range-based advertisement includes one or more of a condition related to a similarity of business types and a condition related to a number of expanded range-based advertisements.

5. The advertisement provision server of claim 4, wherein the expanded range-based advertisement determination unit determines that the expanded range-based advertisement is not capable of being provided in any one of a case in which a similarity between a business type of the membership store and a business type of an affiliate store, in which the target beacon is installed, is equal to or greater than a preset reference similarity and a case in which the number of expanded range-based advertisements assigned to the target beacon is equal to or greater than a preset reference number.

6. The advertisement provision server of claim 1, wherein the target route acquisition unit acquires the target route in consideration of a user condition corresponding to the membership store.

7. The advertisement provision server of claim 2, wherein the beacon recommendation unit selects the beacon to be recommended in consideration of a business type of the membership store.

8. The advertisement provision server of claim 2, wherein the beacon recommendation unit stores a result of an advertisement provided using the target beacon, and selects the beacon to be recommended in consideration of the result of the advertisement.

9. A method for providing an advertisement, comprising:
searching for multiple neighboring beacons located around a reference beacon installed in a membership store based on a location of the reference beacon;
acquiring a target route corresponding to the membership store;
determining whether an expanded range-based advertisement using a target beacon corresponding to the target route is capable of being provided; and
providing an advertisement for the membership store using the target beacon when it is determined that the expanded range-based advertisement is capable of being provided.

10. The method of claim 9, further comprising:
selecting at least some of the multiple neighboring beacons as beacons to be recommended in consideration of the target route,
wherein the target beacon is selected using the recommended beacons.
